(19) United States
(12) Patent Application Publication
(10) Pub. No.: US 2012/0066926 A1
(43) Pub. Date: Mar. 22, 2012

(54) Non-toxic multifunctional nanoparticles using sonication-aided incorporation of dopants

(76) Inventors: Kuniyil Prabhakaran, Fremont, CA (US); Geetha Prabhakaran, Fremont, CA (US)

(21) Appl. No.: 13/317,623

(22) Filed: Oct. 25, 2011

Related U.S. Application Data
(63) Continuation-in-part of application No. 12/135,206, filed on Jun. 9, 2008, now abandoned.

(51) Int. Cl. F26B 7/00

(52) U.S. Cl. 34/386

(57) ABSTRACT

The present disclosure involves multifunctional nanoparticle dispersions and methods for making them using sol-gel chemistry, doping, and sonication. These methods avoid the high thermal budget processes of the reference art. The dispersions can accommodate greater concentrations of nanoparticles, dopants, and ions than has previously been possible since these components can be added during synthesis. The unique optical, magnetic, luminescent, metallic, insulating, semi-conducting, and/or conducting properties of these particles can be utilized to enhance photovoltaic cells, portable electronic devices, and biomedical techniques among other applications.

### RELATED APPLICATION

The present application claims priority to, and is a continuation-in-part of co-pending U.S. Ser. No. 12/135,206, entitled METHODS OF SYNTHESIS OF NON-TOXIC MULTIFUNCTIONAL NANOPARTICLES AND APPLICATIONS, filed on Jun. 9, 2008, which is hereby incorporated by reference in its entirety.

### FIELD

The disclosure pertains to the art of nanotechnology. More specifically, the disclosure provides nanoparticles, nanostructures, and fabrication methods with improved tunability for specialized and diverse applications.

### BACKGROUND

Various other devices, systems, and methods have been presented dealing with nanoparticle synthesis and applications in the fields of: biotechnology, securities technology, medicine, energy, optics, and electronics (among others). Poor efficiency of the solar cells has been a major stumbling block in making use of the mighty sun energy in an effective manner. Among the various options of alternative and renewable sources, solar source is by far the safest and environment friendly option. Therefore any approach that can enhance the efficiency of the solar cell in a cost effective manner deserves special attention.

There have been significant efforts to develop nanoparticles that exhibit interesting functionalities. However, many of the nanoparticles developed so far suffer from the problem of potential toxicity, due to elements such as the heavy metals Cd, Hg, etc. Thus, the use of these nanomaterials for real world applications involving human interaction has been limited, in part due to toxicity risks. This underlines the need for the development of non-toxic nanoparticles exhibiting the aforementioned functional properties.

Indeed, one of the most important applications for nanomaterials is in natural energy generation technology, including solar cells. Conventional solar cells are limited in their performance due to a variety of reasons. First, the light conversion aspect is restricted to the acceptance of intense natural “solar” energy from the sun. Traditional solar cells and panels are not effectively stimulated by artificial indoor ambient light and are also not very effective on cloudy days. Therefore, solar cells are not very reliable in many regions where the weather pattern does not guarantee sunshine. Even in sunny climates solar panels must be positioned at special angles (i.e. 22°) and are not as efficient as they should be with their harvesting potential restricted to the peak sun hours of the day (i.e. 1-7 pm). There have been significant efforts to increase the solar cell efficiency by other means such as using multiple junction material systems, improve the anti-reflection films, use concentrators etc. Successful implementation of spectrum shifting technology is reported for the first time.

Legacy techniques are directed to non-silicon based solar cells by printing or web coating solutions of CIGS onto flexible substrates. The important thing is to develop technologies that are universally applicable to any type of solar cell of any generation. This intrinsic feature of our technology makes it relevant to a wide range of solar cells, including current embodiments as well as prophetic embodiments. The techniques of the present disclosures are designed to work with any kind of solar cells and therefore are termed as “universal”. The present disclosures provide an innovative combination of materials and processes to synthesize transparent formulation of nanoparticles (NP, or NPs) that can be coated on the solar cell surface and thereby increase the efficiency of the cell.

With regard to the formulation of nanostructures on substrates for application in electronic devices, legacy techniques (i.e. using scanning tunneling microscopy (STM) or atomic force microscopy (ATM) tips) for nano-scale manipulation and design are impractical for large-scale industrial manufacturing applications. The present disclosures provide commercially viable methods for independently making nanomaterials with controllable properties and then attaching them on surfaces using self-assembly process. By suitable control of the surface texturing it is possible to achieve spatially selective distribution.

Nanomaterials have been emerging as promising materials for applications in the field of energy. However, large scale use has not been demonstrated. Nanomanufacturing and self-assembly are desired to realize commercialization of this technology. Nanomanufacturing and self-assembly are superior to the fabrication of nanostructures controlled individually by using microscopy techniques (STM & AFM, SEM). One of the most important applications for nanomaterials is in natural energy generation.

The present disclosures also apply to stoichiometric, equilibrium, and non-crystalline (i.e. amorphous) nanomaterials. Legacy techniques are limited by the domain size of the nanomaterial which is explicitly “confined to a dimension less than the mean free path of electrons in the material composition”.

### SUMMARY

The disclosures herein provide: (i) non-toxic nanomaterials in which large amounts of dopant ions can be incorporated through an innovative synthesis process enabling the fabrication of nanoparticles with tunable properties (ii) a transparent formulation containing a mixture of functionalized nanoparticles that can perform spectrum shifting. The disclosure pertains to the use of nanomaterials for enhancing the efficiency of solar cells in an extremely cost-effective manner. More specifically, the disclosures provide the method of making nanoparticle (NP) and its formulation for coating solar cells. The NP present on the solar cell performs the spectrum shifting process and increases the number of photons available to the cell for the conversion to current. The nanoparticles in the transparent coating absorb the UV and/or IR (Down and/or Up conversion respectively) part of the solar spectrum and re-emit in the wavelength range of interest to the solar cell. This CIP also contains the details of the synthesis route as well as the data obtained from solar cells. The optical properties of the NP is tuned by the dopant ions introduced in large concentrations during the formation of the lattice network comprising the host material which is primarily silica (a mixture of the monoxide and dioxide of silicon). The transparent formulation is made by sonicating the fine powder form of the NP with a proportion of water, Ethanol and Glycidoxy silane. This process creates functionalized silica nanoparticles which can be bonded to the reactive surface sites of the solar cell.

The present disclosure includes methods for nanomanufacturing of the nanoparticle formulation and coating on solar cells to achieve enhancement in solar cell efficiency. The nanoparticle formulation is transparent and contains functionalized silica nanoparticles and form a stable coating on the solar cells. Specific embodiments include the I-V plots to show the effect of coating on silicon cells. Other embodiments include depositing a coating on glass to increase the light transmitted for use as a building material to achieve better lighting.

### BRIEF DESCRIPTION OF THE DRAWINGS

FIG. 1 shows the flow chart for the synthesis protocol, according to some embodiments.

FIG. 2 shows the comparison of transmission spectra through the proprietary nanoparticle formulation in a UV transmitting cuvette with that of an empty cuvette, according to some embodiments.

FIG. 3 presents a schematic description of multifunctional nanoparticle coating on a solar cell, according to some embodiments.

FIG. 4 shows measurements (including I-V plots) from solar cells before and after coating with the disclosed nanoparticle formulation. More than 30% enhancement in efficiency is observed after coating, according to some embodiments.

### DETAILED DESCRIPTION

The application possibilities for functional nanoparticles (luminescent, optical, magnetic, metallic, semiconducting, insulating, etc.) is crucially dependent on (1) how well they can be dispersed in ordinary solvents and (2) control of the structure and properties (3) how well they can be distributed on a substrate. The present disclosures propose methods to synthesize non-toxic, ultrafine, spherical particles of diameter 1-10 nm which are brightly luminescent at multiple wavelengths. The synthesis protocol involves a unique combination of sol-gel techniques and sonochemistry. The appropriately chosen precursor molecules are decomposed by sound waves. The key idea involves sonication aided incorporation of dopants into the host lattice while the host lattice is being formed followed by repeated cycles of thermal treatment and sonication. This requires the co-presence of the dopant species and the host material in a solvent medium, which is being sonicated. The sonicated mixture contains nanoparticles which possess the desired functional properties.

This approach of incorporation during formation has several advantages. First, it permits nanoparticles well dispersed in solvent to be obtained directly (i.e. by solubilizing the nanoparticles as they are formed). Traditionally, solubilizing or solvating pre-formed nanoparticles is very difficult or virtually impossible to achieve. According to the present disclosures, nanoparticles including silicon dioxide (SiO₂), titanium oxide (TiO₂), and aluminum oxide (Al₂O₃) particles can be synthesized by decomposition of the respective isopropoxide sol-gels. They can be made functional by doping them with suitable dopants simultaneously with the formation of the host oxide material. This experiment has been performed using the dopants Eu, Fe, Zn, F, Cr, Co, Cu, Sn, Li, K, Mg, Mn, and Ce through their respective salt precursors. The doped nanoparticle dispersions and methods of the present disclosures thus provide several more possibilities and non-toxic or less toxic alternatives to the contemporary quantum dots being studied: i.e. CdSe, ZnSe, PbSe, PbS, ZnS, CdTe and CdHgTe. By tuning the concentration and composition of the doped nanoparticle dispersions of the present disclosures, non-toxic uniformly sized particles can absorb and emit in different regions of the spectrum. The methods of the present disclosures facilitate the production of a well-mixed substantially homogeneous solution of non-toxic nanoparticles with a high concentration of functional dopants. Particle size uniformity preserves crystallinity and optical and magnetic properties. Non-toxic materials permit greater concentrations of photosensitive or magnetically active dopants to increase efficiency, luminescence and power without compromising safety, thereby expanding the range of applications. One of the main features of the disclosures is that the particles continue to exhibit the optical property without altering the transparency of the film. This feature is very important for its application in solar cells.

Another advantage is that dispersions of solubilized, doped nanoparticles are generally cheaper than quantum dots to make than other nanomaterials produced by processes, like annealing and powderization, which requires high thermal budgets. In addition to the increased costs of long, high temperature formation processes, the decomposition products of some of the solvents or surfactants used therein have the potential to interfere with the desired optical properties of the nanocrystals.

Dispersions are an ideal medium for printing inks and toners. Nanoparticle dispersion can be made magnetic for security printing (due to anti-copy property), and authentication, by incorporating magnetic ions as dopants. For example, the magnetic ions of elements including iron (Fe), chromium (Cr), and copper (Cu) can be used.

Dispersions of colored nanomaterials can be produced. Colored nanomaterials produce a particular color (wavelength) or multiple colors of light upon irradiation with suitable photons (i.e. photons of a particular wavelength). Depending upon the particular elements and dopants used the colors can be in the visible range or detectable only through ultraviolet (UV) or infrared (IR) sensitive viewers. Colored or multi-colored nanoparticles dispersed in solvents can be added to polymers to introduce luminescent properties to the polymers. These luminescent polymers can be used for laminating glass for a variety of applications. Our dispersions are entirely compatible with glass because the host material can be chosen to be silicon dioxide (SiO₂) from the precursor tetraethyl orthosilicate (TEOS).

Both “down conversion” and “up conversion” nanoparticle dispersions can be formed. “Down conversion” dispersions absorb UV radiation and emit in the visible region. These are well dispersed in ethanol and can be directly used for applications such as coating the surface of a silicon solar cell. Such dispersions can also be coated on windows to reduce glare and effectively convert natural UV-lighting to artificial, soft white lighting. “Up conversion” dispersions also emit visible light upon absorbing IR radiation. In one embodiment of an “up conversion” dispersion, silica is doped with rare earth ions (f block elements). “Up conversion” dispersions with nanoparticles distributed in a solvent can be obtained by sonicating TEOS with a rare earth salt such as lutetium nitrate (LuNO₃). Nanoparticle formulation containing “Up conversion” materials that convert IR into visible light are particularly useful for using them in less sunny areas and less sunny times (cloudy, rainy etc.).
a. Both “down conversion” and “up conversion” nanoparticle dispersion coatings can be applied to the solar cells at different locations to enhance its efficiency effectively. Incorporation of both types of conversion materials (UV and IR to visible) into a single layer is a possibility. The coating will perform on any type of cell and therefore is considered universal.
b. The effective amount of photons available for the solar cell for the conversion process (photons to electrons and then to current) can be significantly increased by converting the UV and IR components of the solar spectrum to visible light. There may be a small contribution from the anti-reflective property that effectively confines photons incident on the solar cell from being reflected off. One mechanism for achieving or enhancing the anti-reflective property of nanoparticle coatings, cells, and panels is through the use of nano-ring patterns. Nanometer-sized optically active rings show potential for special importance in the field of optical cavities and for use in resonators in which whispering gallery mode resonances are employed.

Other techniques for minimizing energy loss from a solar cell formed from or coated with the nanoparticle dispersions described herein include: (i) adding an insulating layer; (ii) adding back reflector, and (iii) patterning the surface or layer interfaces. For the creation of an insulating layer, oxidation can be used to add an encapsulating capping layer (i.e. SiO₂) to the nanoparticle assembled layer. For the back reflector, a metal such as aluminum can be used to trap energy. For surface or interface patterning, the objective is to create a repetitive cycle of internal reflection or refraction that prevents energy from leaving the host material. Any design that facilitates this without significantly interfering with the optical and magnetic properties of the device is suitable. Using surface and interface patterns incident photons undergo scattering, reflecting and energy is continuously being produced.

With the energy conversion possibilities created by controllable, tunable, nanomaterial dispersions and patterned substrates the term “solar cell” is really just a subset of potential applications or else a misnomer. In some embodiments, the coatings formulated in accordance with the teachings of the present disclosures would be better described as “thermal cells”. Categorically, the coatings of the present disclosures are better described as “energy translators”.

In addition to coating existing energy-harvesting (i.e. solar) cells with nano-dispersions, new cells can be formulated from raw materials (i.e. polymers) with nanoparticles directly incorporated therein. For example, titanium oxide (TiO₂) nanoparticles well dispersed in a solvent can be obtained and employed in a polymer matrix to make highly efficient dye-sensitized solar cells. By selectively choosing the polymers, this manufacturing approach can lead to more flexible, foldable and portable solar cell panels. The perfect spherical shape of the particles provide the largest surface area to make the translation more effective. These energy-harvesting, energy-translating nanopolymers (nanoparticles dispersed in a polymeric matrix) can be used in all of the traditional applications of polymeric materials such as for carrying cases for portable, rechargeable electronic devices.

The useful functionalities of these nanoparticles that make them attractive for applications are provided primarily by their optical and magnetic properties. However, their metallic, conducting, semiconducting, and/or insulating, etc. properties can also be important for certain applications. In a preferred embodiment, the present disclosures emphasizes uniquely designed nanoparticles that are active magnetically as well as optically. The present disclosures emphasizes preferred methods for the synthesis of such nanoparticles.

The tunability of the optical and magnetic characteristics of a set of nanoparticles to produce an array of unique sets of characteristics makes them suitable for many uses. For example, tunability makes nanostructures adaptable for optical fiber applications that require particular wavelengths. Tunability also makes nanostructures suitable for electrical components in regulated industries subject to numerous standards for safety and inter-compatibility.

The various functionalities of individual nanoparticles can be combined to form multi-functional composite structures (omnipotent nanomaterials) capable of light absorption and emission at a plurality of wavelengths in an “all in one” or “all from one” approach. A substrate for nanoparticles can be intentionally designed with a facet pattern that translates into functional units by utilizing reactivity differences throughout the pattern. A facet pattern can be controlled by selecting a suitable sample (i.e. index, misorientation direction and angle) and annealing conditions.

The teachings of the present disclosures enable tailoring nanoparticles with specific functionalities for particular applications. The nanoparticles of the present disclosures find uses in medicine, electronics, batteries (including rechargeable), energy generation, energy conversion (i.e. solar, thermal, UV, IR, visible), fiber optics, sensor devices, catalysts, photonics devices, high density magnetic recording components, recording media, color filters, dyes, optical filters, hair coloring products, flame retardants, corrosion protection coatings, photocatalysis, nonlinear optics, electroluminescent displays, photoluminescent sensors, biological probes, light-emitting quantum dots, quantum dot lasers, etc.

The disclosures herein are centered around the controlled synthesis of spherically shaped, largely and multiply doped, optically active, inorganic oxide nanoparticles (NP) (Example SiO₂, Al₂O₃)) by the decomposition of precursor molecules through a unique combination of sol-gel processes, sonochemistry and thermal processing. Both metal (M1) and bi-metal (M1, M2) isopropoxide sol-gels can be further processed with sonication and doping (D) to generate spherical shaped luminescent NP. Optionally, the solutions may also be annealed to encourage the proliferation of nano-scale structures. Also optional, is re-sonication of the solutions to create greater uniformity of nanoparticle size distribution.

The following symbology represents the various oxide nanostructure possibilities:
i. Dopants (D), Sonication, (anneal, re-sonicate)
   M1-Isopropoxide - - - →M1-D-Oxide
   M1M2-Isopropoxide - - - →M1M2-D-Oxide
   Tetraethyl orthosilicate (TEOS) - - - →Si-D-Oxide NP
ii. (dispersed in Ethanol)

This approach can be generalized and applied to other systems (including non-oxide systems) as well. The use of bimetallic precursors and a greater array of non-toxic soluble dopants opens up enormous possibilities. When applied to security applications (i.e. ink and toner dispersions), this approach enables an infinite number of codes through the judicious combination and alteration of variables such as: (i) host materials, (ii) dopants (number, concentration, wavelengths, etc.), (iii) synthesis parameters (particle size and shape) and (iv) synthesis conditions (sonication power/rate/duration, annealing temperature/duration, etc.). Thus, the same host material can be used as a matrix for distributed NP with a wide range of properties and multiple functionalities depending upon numerous input variables (i.e. wavelength of light used for stimulation; existence, direction, and strength of a magnetic field, etc.). For example, largely iron doped alumina is a black material which emits red light upon shining with ultraviolet light and emits near IR light upon shining with green light.

In a preferred embodiment of the present disclosures, omnifarious oxide nanoparticles that emit brightly at multiple wavelengths are synthesized. Different types of oxide sols can be made using different precursors. For example, aluminum isopropoxide can be used as a precursor for an alumina oxide sol and tetraethoxy orthosilane (TEOS) can be used as a precursor for a silica oxide sol. The sol is prepared by sonicating the isopropoxide in water.

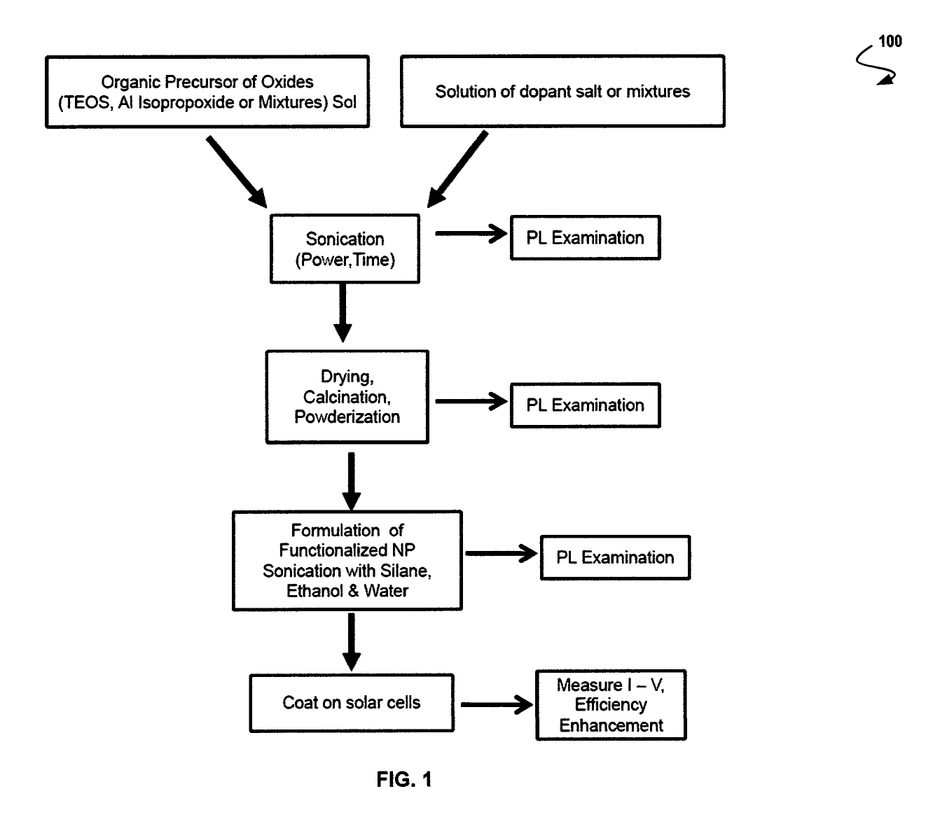

FIG. 1 depicts a flow chart 100 to describe the synthesis procedure. The mixture is sonicated at bearable warmth and a clear solution is formed. This is followed by the addition of the dopant source, preferably in a salt form soluble in water. The doped mixture is sonicated thoroughly, transferred into a crucible, and (optionally) annealed at a temperature at or above the decomposition temperature of the oxide. After annealing, the resulting material is found to be in the nanoparticle form. The particles range in size from 5-100 nm and spherical shapes predominate. The size of the particles can be tuned by optimizing the sonication conditions. Uniformly sized particles can be obtained by re-sonicating the annealed material.

The advantage of this manufacturing approach is that the light emitting dopant ions (of one or more variety) are readily available for incorporation into the host lattice during its formation. Therefore, it is possible to control incorporation of the desired ions to achieve concentration levels substantial enough to be effective with a noticeable alteration of the optical and magnetic properties of the host matrix material. The dopants can be made more effective by electrochemical treatment, which results in well separated cations and anions.

Functional nanoparticles synthesized as per the disclosure can be further functionalized to terminate with organic groups (i.e. carboxylic acid groups, phosphonic acid groups, sulfonic acid groups, amine containing groups, etc.) for attachment and labeling of cells. Linker molecules can be used in which one end reacts with the organic group on the functionalized nanoparticle while the other end of the linker reacts with a reactive site on the target cell. Linker molecules have also been known to have other benefits including: passivating nanoparticles (NPs); increasing stability, light absorption and photoluminescence; and enhancing solubility in some organic solvents. Longer linker molecules, known as “spacers” (i.e. carbon spacers between 6 to 20 carbon atoms) may also be used to prevent steric hindrance during the interaction between the reactive group on the target molecule and the reactive group on the functional nanoparticle (or on its spacer).

According to one embodiment, iron oxide nanoparticles are formed on a silicon substrate. Silicon wafers with as-incorporated amorphous iron oxide nanoparticles exhibit superparamagnetic behavior but after annealing the same samples show ferromagnetic property attributed to transformation of the amorphous iron oxide into crystalline nanoparticles of Fe. Upon annealing, experimental results clearly demonstrate that Fe₂O₃ particles are reduced to elemental Fe. The reduction temperature of iron oxide on a semiconductor substrate is dictated by the temperature at which the semiconductor element oxide desorbs. Light emission intensity spectra as a function of sample temperature suggests that the process is thermally activated and that the origin is exciton related.

According to another embodiment a semiconducting silicide such as β-FeSi₂ is used as the host substrate for nanoparticle bottom-up derivation. The use of β-FeSi₂ is of special interest because it is covalent and environmentally friendly with a direct bandgap. It shows potential for use as a silicon-based light emitter. More specifically, β-FeSi₂ appears especially useful for fiber optic communications because of the wavelength(s) of light it emits.

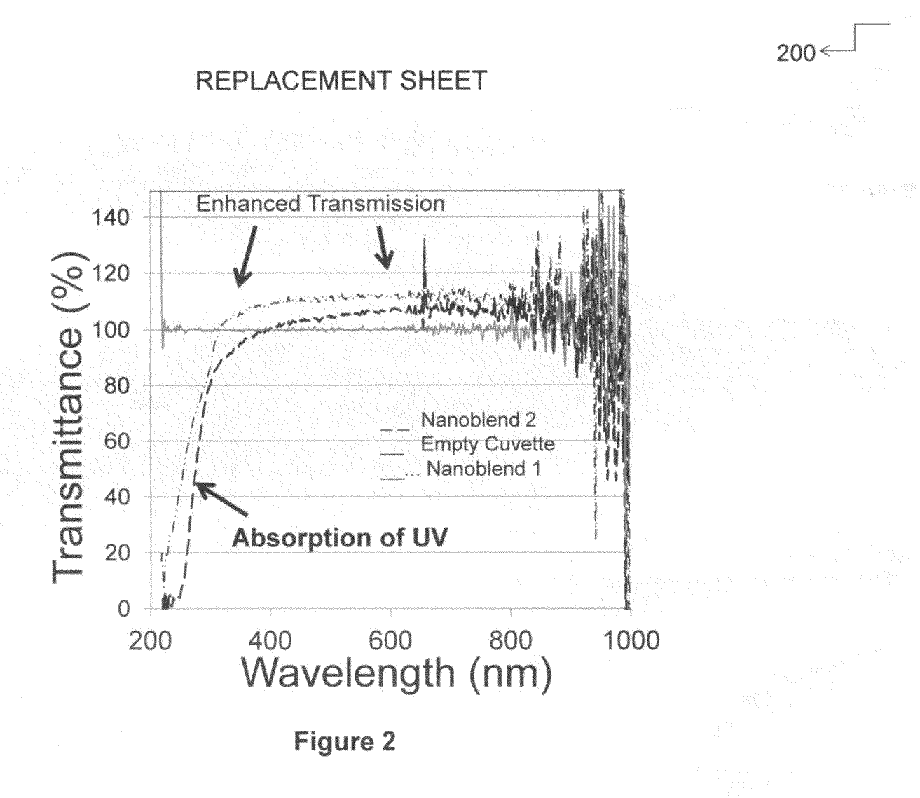

FIG. 2 shows a comparison 200 of the optical transmission spectra from the NP formulation A cuvette made of UV transmitting polymer is used for taking the sample. Attenuation of the UV signal and an increment in the transmitted light is clearly observed. A deuterium lamp was used as source. Attenuation of UV and enhancement in the visible region are indicated.

In security coding, genuine records, disks, or product labels would show the unique pattern of emission dependent on stimulation wavelength. Counterfeit goods and pirated trade labels, in contrast, would not show the unique and variable (stimulation energy dependent) emission profile of their authentic counterparts. Sophisticated copycats may be able to duplicate a single emission profile (i.e. at a single energy stimulation wavelength) but by increasing the number and variability of dopants used in the nanomaterial dispersions, a multi-tiered complex code that is impossible to reverse engineer can be created.

Addition of one or more magnetically active ion into the host lattice induces the occurrence of unique emission lines upon the application of a magnetic field to the nanomaterial. This magnetically active material can be used to enhance security by providing additional discriminatory features to differentiate counterfeits or copies from authentic, certified, or licensed products. Counterfeit producers may find it more difficult to become aware of and to replicate an authentic label's magnetic sensitivity. Magnetically active nanomaterials can also be used for bio-applications, where an external magnetic field can be used to achieve targeted delivery of the drug molecule.

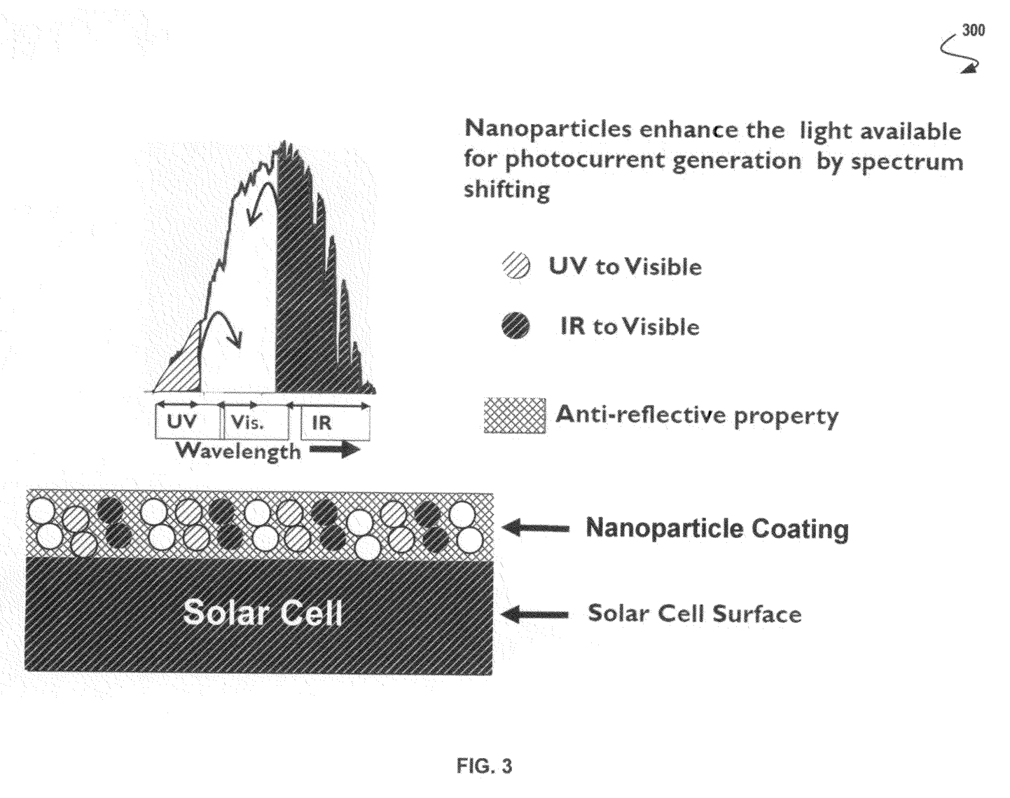

FIG. 3 shows the schematic description 300 of the effect of coating on the solar cell emission of white light by a combination of red, blue and green emitting ions incorporated into the same nanoparticle. Different dopants in the nanoparticle coating can be used to enable it to convert several different forms of energy to visible light, enhances solar cell efficiency by increasing the effective amount of visible light available for subsequent conversion to electrical energy. A broad emission spectra characteristic of white light can also be generated from the singly doped NP due to crystal field effects. For example, silica NPs sonochemically synthesized from TEOS have been shown to emit intense white light.

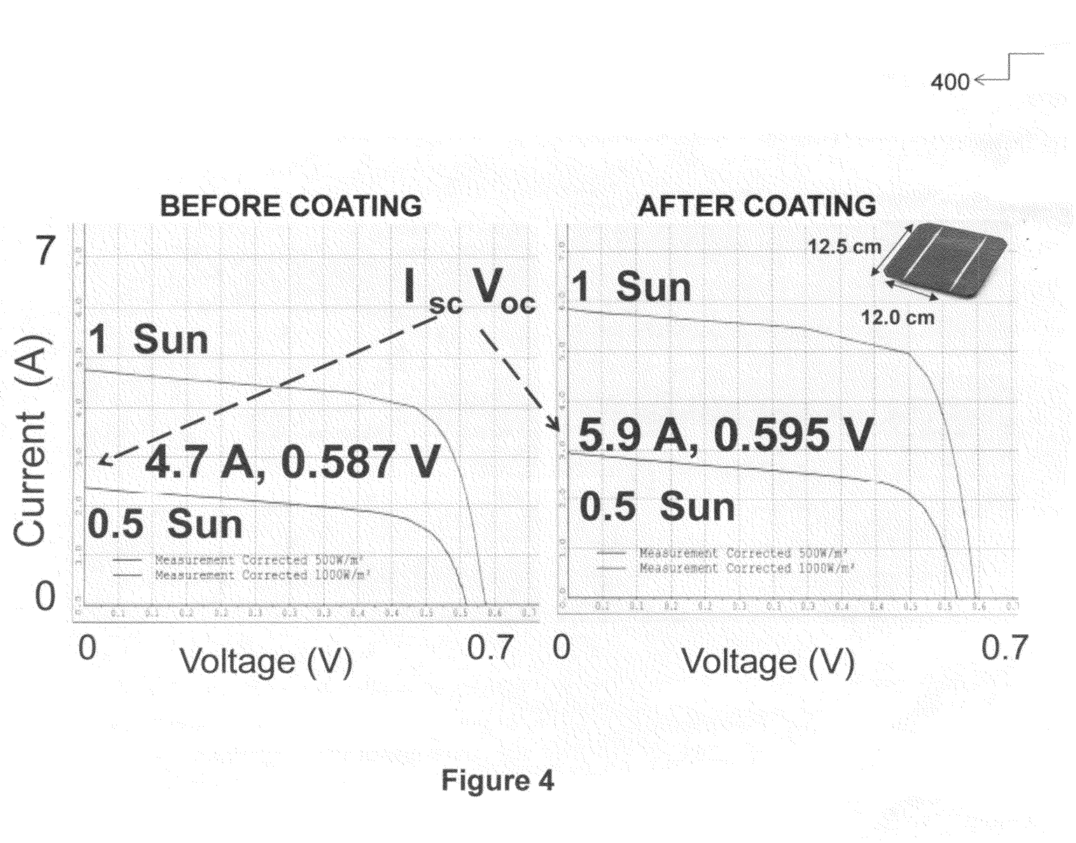

FIG. 4 displays the actual data 400 from a silicon cell before and after coating with the NP formulation. As shown, there is a dramatic increase in the current generated which is attributed to the coated material. FIG. 4 shows the measured (I-V) plots from solar cells before and after coating with our proprietary nanoparticle formulation. More than 30% enhancement in efficiency is observed after coating.

The light emission property of the NPs attached to or inserted within bio-cells can distinguish the cell from a group of other cells. Other properties of NPs can also be used in this manner (i.e. magnetic, metallic, insulating, semiconducting, conducting, etc. properties).

The ability of nanostructures to self-assemble permits their self-endowment with unique functions and qualities upon formulation before being integrated into larger systems with other components. This increases the stand-alone value of nanostructures. One application for stand-alone nanostructures is incorporation upon semiconductor substrates. The idea of incorporating externally synthesized nanoparticles onto semiconductors has been termed a “plug and play” approach to the multi-functionalization of silicon. This semiconductor fabrication method is also referred to as a “bottom-up” approach and can be combined with spintronics for the production of cutting-edge nanoelectronic devices.

A preferred embodiment of nanostructure semiconductors is the bottom-up formulation of β-FeSi₂. Silicon is particularly well suited as a substrate for nanostructures because its atomic steps: (i) have high reactivity, (ii) exhibit excellent affinity for adsorbing foreign species, and (iii) act as nucleation centers for further growth. However, other non-silicon or non-pure silicon (i.e. silicon compound) materials can also be used as nanostructure substrates provided they do not impair the unique functionalities (i.e. luminescence, optical, magnetic, metallic, conducting, semiconducting, insulating, etc.) of nanoparticles.

To further increase the functional possibilities for nanomaterial semiconductors, the step sizes and edges of the substrate surface can be manipulated via means such as traditional etching. When annealing is used as part of the nanostructure formulation process, the particles remaining after annealing tend to be of uniform size and to nucleate preferentially at surface step edges. The size distribution of the NPs deposited or formed on a substrate surface tends to be narrow because when the NP suspension is prepared (i.e. NPs suspended in ethanol) the larger particles sediment out of solution early on. This uniformity is advantageous for ensuring predictable and homogenous properties throughout the substrate.

Intentionally etched semiconductor surfaces can also be used to direct the assembly of nitride linings. The linings form from bifunctional nitric oxide during nitridation reactions at elevated temperatures. Nitric oxide is bifunctional in that both the nitrogen and oxygen species are reactive when the molecule breaks down (i.e. on a silicon substrate at high temperatures). Oxygen etches silicon while nitride deposits itself in particular patterns corresponding to the locations etched by oxygen. Through the dissociative adsorption of nitric oxide from a substrate, reactive oxygen becomes available to etch the substrate. Oxygen atoms generate reactive centers by forming dangling bonds and unsaturated bonds on silicon. Nitrogen atoms respond by becoming attached at these same positions. The combined etching processes of step band formation and reactive center generation produce a pattern that precedes and serves as a template for the deposition of nitride linings. Nanoparticle dispersions can then be deposited upon the nitride linings.

Nanostructures can be designed to intake different sources and forms of energy as stimulation depending on the application. For example, some nanostructure embodiments may be stimulated by lasers (i.e. He—Ne or Ar) while other embodiments depend upon ultraviolet (UV), infrared (IR), or visible light. In addition, some nanostructure embodiments may be stimulated by non-light energy sources (i.e. radio frequency waves (RF), microwaves, etc.). Some omnipotent or multifunctional nanomaterials (i.e. with a variety of dopant compositions or sizes) absorb and react to more than one source and form of energy for stimulation. Raising the temperature (i.e. during the annealing process or as part of the stimulation process) and/or stimulating the nanostructure surface with light beams both have been shown to diminish the spectroscopy signals by inducing desorption of excess NPs and/or bombarding NPs from a surface. NPs that absorb energy at lower temperatures and or from sources other than light beams could prevent these losses. Alternatively, an insulating layer above the NP layer can reduce surface displacement losses.

Similarly, nanostructures can be designed to output different sources and forms of energy as emission depending upon the application. In solar cell applications one desired energy output form is visible light which can be produced by the nanomaterials from both IR and UV forms. The solar cell then uses the visible light (direct and indirect from IR, UV, etc.) to make electrical energy.

The nanoparticles of the present disclosures can be applied in medical applications including providing pinpoint lighting in biodiagnostic probes precisely at a target site. The nanoparticles can also be used to distinguish certain cells requiring treatment (i.e. malignant cells) from others via superficial attachment or internal labeling treatment options that reach the NP cells exclusively, can then be used to provide more intense and more efficient therapy that does not unnecessarily weaken healthy cells.

Alternatively, NPs can also be used on the other side of the reaction, applied to the drug molecules or other external treatment agents rather than internal cells. Incorporating NPs within therapeautic agents can produce formulations that will only react with afflicted target cells. In one embodiment, NPs can be included within coatings on therapeautic agents (i.e. molecules, drugs, capsules, etc.) so that the agents are only attractive to (absorbed by) and reactive with select cell types (i.e. afflicted target cells).

In the electronics field, the technology of the present disclosures is especially advantageous for mobile personal electronics. Although the mobility of electronics has come a long way, professionals are still restrained by the continual need to find an electric outlet to recharge. This interferes with productivity and impairs flexibility and freedom. Many popular public working sites (i.e. coffee houses and airports) do not have one outlet per person and people must hunt for electrical outlets and stretch cords across walking spaces creating a tripping hazard. Further, with the increasing popularity of working on-the-go such public sites are likely suffering a substantial increase in their energy bill by customers and non-customers alike that continually recharge or plug-in to free power.

The NPs dispersions of the present disclosures, with their ability to harvest and transform light and energy, can provide an alternative that will benefit everyone. By attracting and trapping ambient room energy (i.e. including inside artificial light and heat), functional nanoparticles (FNPs) can create energy compatible with mobile personal electronic devices. Other contemporary non-electrical power alternatives are weaker because they require intense natural solar energy and charging periods that cannot keep up with the power depletion rates of ordinary users (i.e. with habits including simultaneously running several programs, downloading large files, long working sessions, etc.) Thus, with the present disclosures, professionals need not live in Phoenix (or another site of dependable sunshine) to recoup the benefits of their investment in new energy technologies. Further, professionals whose work requires electronic devices can work from a much greater array of places without increasing the energy bill of others (i.e. coffee house owners, municipal libraries, etc.) when working off-site. In some embodiments, to economize on device size the display surface could also function to capture energy.

The magnetic properties of the FNPs of the present disclosures may also be tailored for use in electronic device memories. FNPs can create physically smaller internal memories with more storage space and faster access and retrieval.

### Additional Embodiments

Embodiment 1. A method for fabricating spherical shaped, size ranging from 1 nm-100 nm, largely doped silicon oxide nanoparticles wherein multiple dopant ions introduced during sol-gel sonication
Embodiment 2. The method of embodiment 1 wherein the doped silicon oxide nanoparticles of embodiment 1 are made into a transparent formulation comprising functionalized nanoparticles by sonicating with water, ethanol and silane, coating on solar cell, which perform spectrum shifting and enhance the efficiency.
Embodiment 3. The method of embodiment 2 wherein dopants are selected from Eu, and Cr, being capable of spectrum shifting from UV to visible region, using a coating on a solar cell to enhance the efficiency by >30%
Embodiment 4. The method of embodiment 2 wherein the coating is on CIS, CIGS, Amorphous Si solar cells enhances the efficiency in the range 5-15%
Embodiment 5. The method of embodiment 2, wherein the formulation is coated on top of the outer glass plate of solar panel to enhance the measured efficiency by 5-10%.
Embodiment 6. The method of embodiment 5, wherein the measured efficiency is measured under sun light.
Embodiment 7. The method of embodiment 2, wherein the formulation is coated on glass to increase the transmission.
Embodiment 8. The method of embodiment 2, wherein the nanoparticles are synthesized through combination of sol-gel, sonication, and thermal treatment.
Embodiment 9. The method of embodiment 2, wherein the nanoparticles are highly dispersible in solvents, silicon oil.
Embodiment 10. The method of embodiment 2, wherein the coating is a liquid to enhance the efficiency of the cell.
Embodiment 11. The method of embodiment 10, wherein the extent of enhancement is dependent on the location of the nanolayer in the cell structure. Possible locations are above the bare silicon surface (best performance), top of the AR layer, sandwiched between AR layers an top of the outer glass plate.
Embodiment 12. The method of embodiment 2, wherein the nanoparticles exhibit an absorption-emission characteristics using a nanolayer tuned to match with that of the solar cell material (for maximum performance).
Embodiment 13. The method of embodiment 2, wherein the formulation is coated on a UV transmitting polymer (used instead of an outer glass plate).
Embodiment 14. The method of embodiment 2, wherein the formulation can be coated on thin transparent polymer films (to be used in a stickers for flexible, foldable solar panels).
Embodiment 15. The method of embodiment 2, wherein the formulation can be added to any material to introduce luminescent properties.
Embodiment 16. The method of embodiment 2, wherein the formulation includes multiple dopants to bring in the up-conversion property to the formulation where the conversion from IR to visible region is possible.
Embodiment 17. A dispersion, wherein the dispersion is produced by sonicating a semiconductor precursor with a rare earth salt.
Embodiment 18. The dispersion of embodiment 17, wherein the semiconductor precursor is tetraethyl orthosilicate (TEOS) and the rare earth salt is lutetium nitrate (LuNO₃).
Embodiment 19. The dispersion of embodiment 17, wherein the solvent is ethanol and at least one dopant is selected from the group consisting of: Eu, Fe, Zn, F, Cr, Co, Cu, Sn, Li, K, Mg, Mn, and Ce.
Embodiment 20. The dispersion of embodiment 17, wherein the nanoparticles form ring structures when the dispersion solidifies.

From the above descriptions of the embodiments, those skilled in the art will perceive improvements, changes and modifications. Such improvements, changes and modifications within the ordinary skill of the art are regarded as covered by the appended claims directly or as equivalents.

What is claimed is:

1. A method of producing a nanoparticle dispersion using sonication comprising:
dissolving an isopropoxide sol-gel or tetraethyl orthosilicate (TEOS) in a solvent to form a solution;
adding a dopant to the solution;
sonicating the solution;
performing drying, thermal treatment and powderization to result in a powder;
re-sonicating the powder with ethanol and silane.
